(19) United States
(12) Patent Application Publication
(10) Pub. No.: US 2006/0077020 A1
(43) Pub. Date: Apr. 13, 2006

(54) Circuits and manufacturing configurations of compact band-pass filter

(75) Inventors: Chung-Hsiung Wang, Hsinchu (TW); Keng-Hong Wang, AnDing Township (TW)

Correspondence Address: Bo-In Lin, 13445 Mandoli Drive, Los Altos Hills, CA, 94022, US

(73) Assignee: CYNTEC COMPANY

(21) Appl. No.: 10/963,705

(22) Filed: Oct. 13, 2004

(51) Int. Cl. H01P 1/203

(52) U.S. Cl. 333/204

(57) ABSTRACT

A filter circuit that includes a thin film layer supported on a substrate serving as a medium layer for a capacitor formed between a top electrode layer and a bottom electrode layer formed above and below the thin film layer. The top electrode layer is patterned into microstrips for functioning as an inductor for the filter circuit.

### BACKGROUND OF THE INVENTION

1. Field of the Invention

This invention relates generally to the device configuration and processes for manufacturing band-pass filters (BPF). More particularly, this invention relates to an improved circuit and packaging configuration and manufacturing process for making compact band-pass filters.

2. Description of the Prior Art

For those of ordinary skill in the art, the configurations and the processes of manufacturing the band-pass filters (BPF) are still faced with technical challenges due to the fact that noises and harmonic resonance signals of higher and lower frequencies cannot be effectively filtered out. Furthermore, there are limitations to further improve the form factor and to reduce the size of the BPF circuits due to a conventional configuration by assembling and packaging the BPF by using different circuit components, e.g., circuit components of capacitors and inductors. As more and more mobile communication devices, e.g. cellular phones and personal digital assistant (PDAs), are become popular, there is ever increasing demand to provide BPF with high peak and low noise that can be further miniaturized to fit into very compact portable devices. Due to conventional method and configurations of assembling electronic components into BPF, a person of ordinary skill in the art still have difficulties to satisfy such demands due to these technical limitations.

Referring to FIG. 1A for the conventional BPF formed by using chip inductors, spiral inductors, chip capacitors, and MIM capacitor to form the band pass filter as that shown in FIG. 1B. Such BPF occupies large areas thus greatly limiting the flexibilities for miniaturization. Furthermore, the conventional BPF circuits as that shown in FIG. 1C includes two symmetrical resonators connected in parallel. The bandpass waveform is shown in FIG. 1D. One of the resonators has a resonant frequency f0 at the center of the passband and another resonator has a resonator frequency at a different frequency for eliminating the transmission of signals at that frequency. The conventional BPFs as shown still have the limitations that there are spurious signals passing through at the low frequencies and resonant harmonic noises at higher frequencies. These signals affect the quality and performance of signal transmissions in the telecommunication systems.

Sasaki et al. disclose in U.S. Pat. No. 6,326,866, entitled “Bandpass filter, diplexer, high-frequency module and communications device”, a bandpass filter. The BPF is provided for forming attenuation extremes on both sides of a passband. Multiple microstrip line resonators, one end of each being an open terminal and the other end connecting to a ground electrode, are provided in a row, and the inner microstrip line resonators are bent in a C-shape so that the open terminals of the outer microstrip line resonators project further than the inner microstrip line resonators. The line of sight between the open terminals of the microstrip line resonators is improved and capacitance is formed there, so that Sasaki's invention is able to form attenuation extremes on both sides of the passband, to increase the amount of attenuation. Sasaki's technique however is limited by the larger size in forming the capacitors that spread over the horizontal directions. The BPF of Sasaki is further limited by the form factor of the package that does not allow convenient and compact connections to external circuits due to a requirement that separate connections are required to implement the BPF as that disclosed in this patented invention.

In U.S. Pat. No. 6,700,462 entitled “Microstrip line filter combining a low pass filter with a half wave bandpass filter”, Nakamura et al. disclose a plurality of composite elements arranged in parallel with each other on a substrate. The composite elements each include a rectangular microstrip line element, an input microstrip line and an output microstrip line. The microstrip line element has one longer side, the other longer side, one end and the other end, and the input microstrip line is connected at the one end to the one longer side while the output microstrip line is connected at the other end to the other longer side. The composite elements are cascaded to constitute a low-pass filter. As Nakamura's invention provides circuit configurations that may be useful as a reference, Nakamura's inventions do not provide specific solution to provide BPF configurations that would be useful to improve the BPF as now available by conventional technologies to overcome the limitations and difficulties as now encountered by a person of ordinary skill in the art.

In a Patent Publication 20030095014, Lao et al. disclose a connection package for high-speed integrated circuits employed in optical, electronic, wired or wireless communication. The connection package includes a substrate having microstrips for communicating signals between the IC pads and external terminals. A pair of differential microstrips can be positioned closer to each other near the IC pads and create capacitive coupling. Such coupled capacitance allows the width of the microstrips to be reduced. A portion of the coupled microstrips near the IC pads can be widened to increase the capacitance so that the overall transmission path can become an all-pass network—from the IC pads, through the bonding wires, to the microstrips. The rest of the portions of the microstrips can be tapered out to their respective external connectors. In addition, a multi-layer package may include a substrate, at least one coaxial external terminal formed at the side of the package for conducting a high-speed signal, BGA connectors formed at the bottom of the package for conducting low-speed signals, a microstrip for connecting the high-speed signal to the coaxial terminal, and microstrips and internal coaxial connectors for connecting the low-speed signals to the BGA connectors. There is an advantage of the packaging configuration that maintains substantially constant characteristic impedance throughout the signal transmission paths in the package. However, the configuration and method of employing the mircrostrips do not provide a method to resolved the difficulties and limitations of making compact and high performance bandpass filters.

In US Patent Application 20020118081, Liang et al. disclose a hybrid resonator microstrip line filters form a substrate that includes a ground conductor and a plurality of linear microstrips positioned on a the substrate with each having a first end connected to the ground conductor. A capacitor is connected between a second end of the each of the linear microstrips and the ground conductor. A U-shaped microstrip is positioned adjacent the linear microstrips, with the U-shaped microstrip including first and second extensions positioned parallel to the linear microstrips. Additional capacitors are connected between a first end of the first extension of the U-shaped microstrip and the ground conductor, and between a first end of the second extension of the U-shaped microstrip and the ground conductor. Additional U-shaped microstrips can be included. An input can coupled to one of the linear microstrips or to one of the extensions of the U-shaped microstrips. An output can be coupled to another one of the linear microstrips or to another extension of one of the U-shaped microstrips. The capacitors can be voltage tunable dielectric capacitors. Special functional applications by configuring the microstrips in different shapes are disclosed. These microstrip configuration however do not provide a solution or device configuration to form compact and bandpass filters with improved form factors while providing high peak and low noise performance.

Therefore, a need still exists in the art of design and manufacture of bandpass filters to provide a novel and improved device configuration and manufacture processes to resolve the difficulties. It is desirable that the improved BPF configuration and manufacturing method can be simplified to achieve lower production costs, high production yield while capable of providing BPFs that are more compact with lower profile such that the inductor can be conveniently integrated into miniaturized electronic devices. It is further desirable the new and improved BPF and manufacture method can improve the production yield with simplified configuration and manufacturing processes.

### SUMMARY OF THE PRESENT INVENTION

It is therefore an object of the present invention to provide a new structural configuration and manufacture method for manufacturing an bandpass filter (BPF) with simplified manufacturing processes to produce BPF with improved form factors having smaller height and size and more device reliability. It is further an object of the invention to improve the bandpass filtering performance by providing special circuit configuration such that the noises and harmonic resonance can be further reduced.

Specifically, this invention is a simplified method to manufacture a filer circuit by employing a thin film as a medium layer between a top and a bottom electrode layer. The method further includes a step of patterning the top and bottom electrode layer into microstrips to function as inductors and coupling capacitors to have a combine function as a filter circuit. The method further includes step of forming the filter circuit by defining high and low attenuation frequencies above and below the bandpass filter rang such that the performance of the bandpass filter is greatly improved. With the simplified manufacturing method, the production costs and time are significantly reduced, and the product reliability is greatly improved.

Briefly, in a preferred embodiment, the present invention includes a bandpass filter that includes a top electrode layer and a bottom electrode layer disposed above and below a thin dielectric layer supported on a substrate wherein the top and bottom electrode layer having microstrips to function as inductors and capacitors. And, the bandpass filter further includes an attenuated transmission frequency outside of a bandpass frequency rang of the bandpass filter

This invention discloses a method for manufacturing a filter circuit. The method includes a step of forming a thin film layer on a substrate to function as a medium layer and forming a capacitor by forming a top electrode layer and a bottom electrode layer above and below the thin film layer. The method further includes a step of patterning the top electrode layer into a microstrip for functioning as an inductor for the filter circuit

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIG. 1A is a top view of a conventional bandpass filter (BPF) and FIG. 1B is the circuit diagram of the conventional BPF.

FIGS. 1C and 1D show a circuit diagram and waveform respectively of the passband of a conventional bandpass filter.

FIG. 2A is an equivalent circuit diagram of a BPF of this invention and FIG. 2B is a top view for showing the micro-strip implementation to form the BPF of FIG. 2A.

FIGS. 2C-1 to 2C-10 is a series of cross sectional views and perspective views for showing the layer structures and processes for manufacturing the band pass filter of this invention.

FIG. 3A is an equivalent circuit diagram of another embodiment of a BPF of this invention and FIG. 3B is the top view for showing the micro-strip implementation to form the BPF of FIG. 3A.

FIGS. 4A and 4B are a circuit diagram and waveform of a BPF of this invention.

FIGS. 5A and 5B are a circuit diagram and waveform of another BPF of this invention.

FIGS. 6A and 6B are a circuit diagram and waveform of another BPF of this invention.

FIGS. 7A and 7B are a circuit diagram and waveform of another BPF of this invention.

FIGS. 8A and 8B are a circuit diagram and waveform of another BPF of this invention.

FIGS. 9A and 9B are a circuit diagram and waveform of another BPF of this invention.

FIGS. 10A and 10B are a circuit diagram and waveform of another BPF of this invention.

FIGS. 11A and 11B are a circuit diagram and waveform of another BPF of this invention.

FIGS. 12A and 12B are a circuit diagram and waveform of another BPF of this invention.

FIGS. 13 to 17 are circuit diagrams of different BPF implemented with microstrips with semi-lumped distributed configuration of this invention.

### DETAILED DESCRIPTION OF THE PREFERRED EMBODIMENT

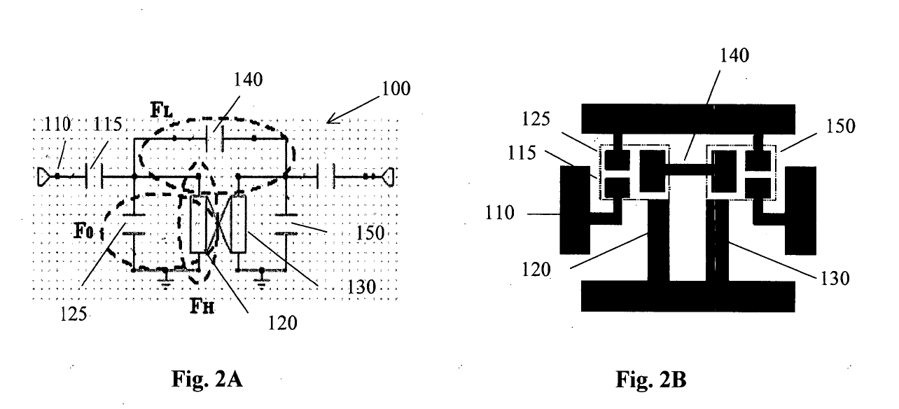

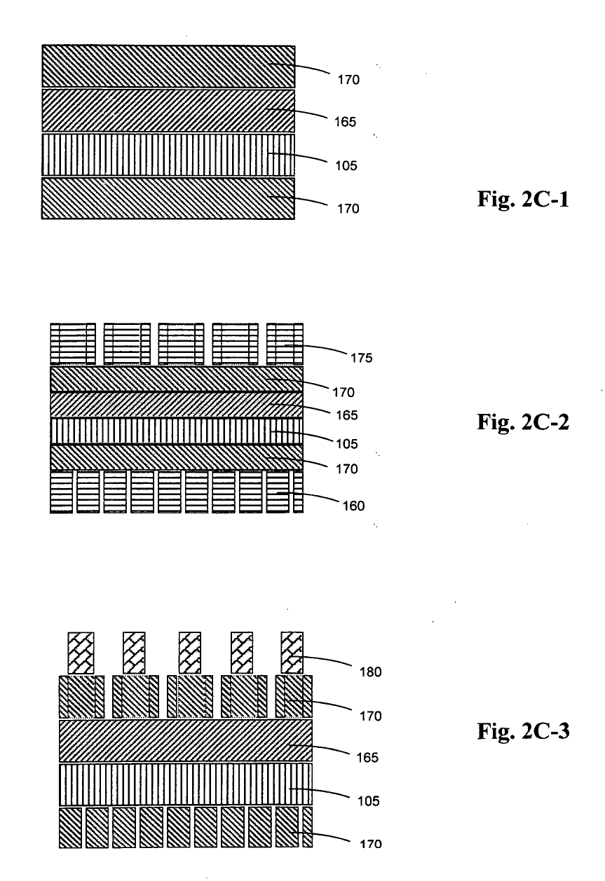

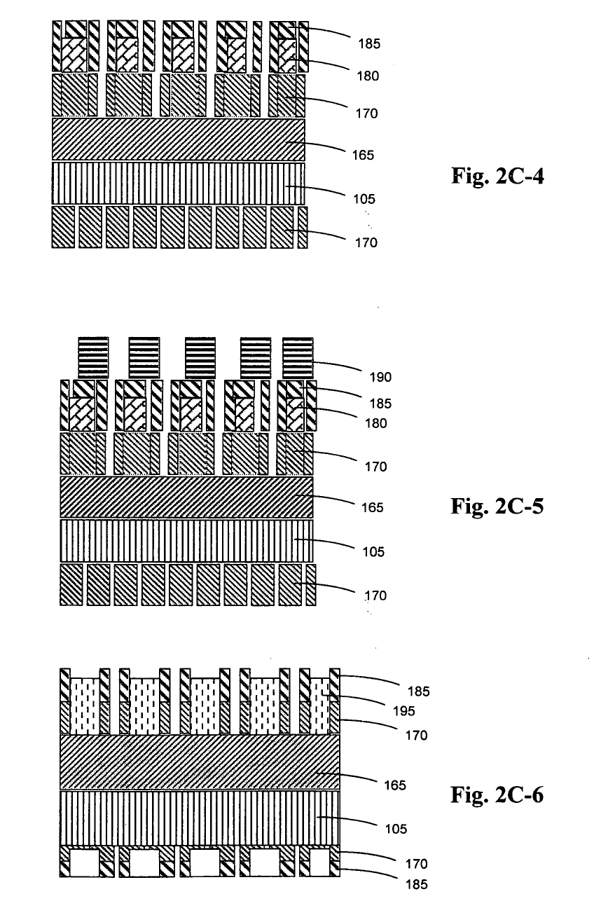

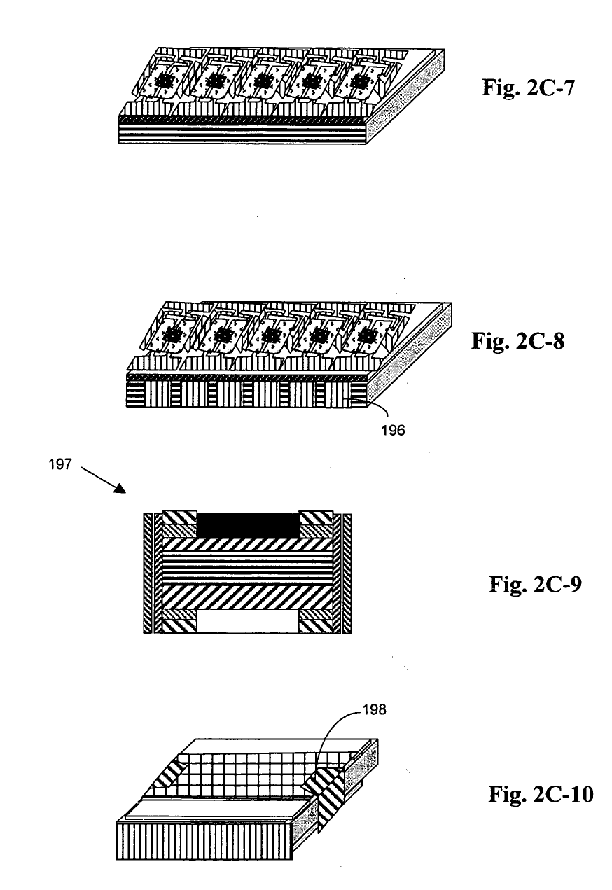

FIG. 2A shows a circuit diagram of a bandpass filter 100 and FIG. 2B is a top view of the micro-strip implementation supported on a substrate 105 of this invention implemented as a semi-lump distributed circuit by a micro-strip line or strip line configuration as that shown in FIG. 2B. The micro-strip 120 is serial connected to the input line 110 with a serially connected capacitor 115 to generate a high frequency resonance f_{H}. The micro-strip 120 connected in parallel to a capacitor 125 to generate a resonance frequency at a transmission frequency f0. The micro-strip 120 combined with a coupled micro-strip 130 with a another capacitor 140 connected in parallel that in combination with an external feedback capacitor 150 to generate a low frequency resonance at a low frequency f_{L}. The BPF 100 is configured as a low frequency depression BPF for transmitting a band-pass signal with a depressed low frequency with reduced low frequency noises.

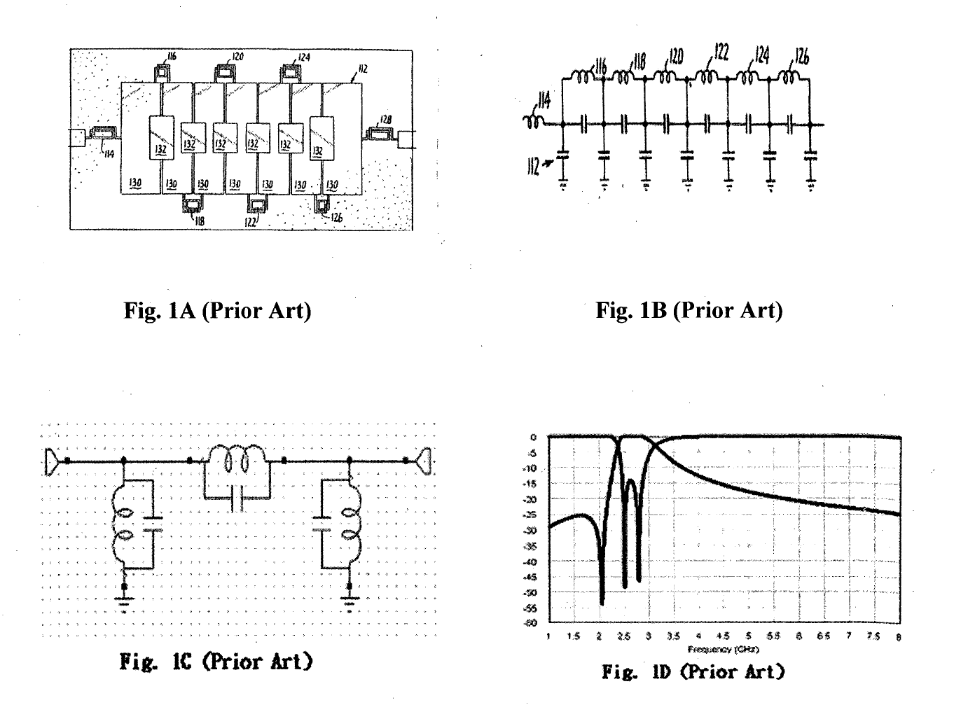

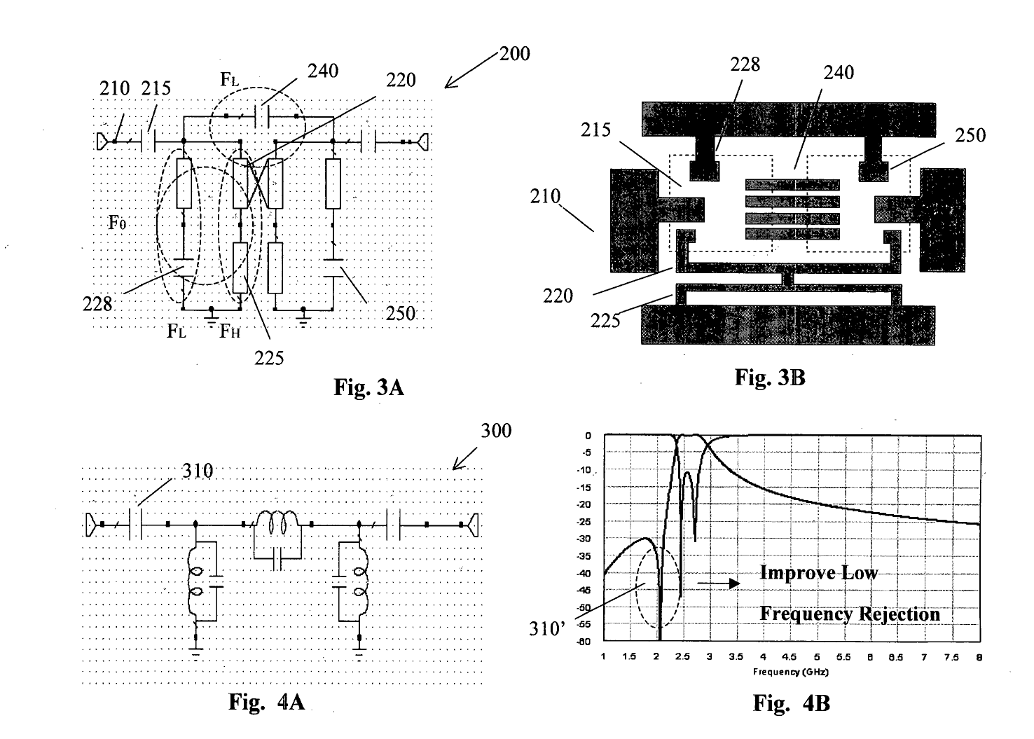

Referring to FIGS. 2C-1 to 2C-10 for a series of cross sectional and perspective views for showing the manufacturing processes of the BPF shown in FIGS. 2A and 2B. Referring to FIG. 2C-1, a metal layer 170, e.g., a copper, silver or gold layer of four to fifteen microns in thickness, is deposited on the back of the ceramic substrate 105 as a ground metal layer. The ceramic substrate 105 is preferably an aluminum oxide substrate having a thickness ranging from 0.3 to one millimeter. A glass layer 165 is formed as a thin film insulation layer is printed on top of the ceramic substrate. A bottom electrode layer 170 composed of copper; silver or gold with a thickness ranging from three to fifteen micrometers is formed on top of the thin film insulation layer 165. A planarization process is performed on the bottom electrode layer 170. Referring FIG. 2C-2, photoresist masks 175 are applied to pattern the ground layer 160 and the bottom electrode layer 170. The patterned bottom electrode layer function as the bottom electrodes for the capacitors in the BPF. In FIG. 2C-3, an adhesion layer having a thickness ranging between 0.01 to 0.5 micrometers are formed on top of the bottom electrode layer 170. Referring to FIG. 2C-4, a thin film dielectric layer 185 composed of silicon nitride is formed on top of the adhesion layer 180. The dielectric layer 185 is a medium layer for the capacitor between the top and the bottom electrodes. FIG. 2C-5 shows the deposition of a top electrode layer 190 on top of the dielectric layer 185. The top electrode layer 190 composed of copper; silver or gold has a thickness ranging between four to fifteen micrometers. The top electrode layer 190 is patterned to form the top electrodes of the capacitor and the inductor as shown in FIGS. 2B. The bottom electrodes of the coupling capacitor and the feedback capacitor are connected through a via-connection through the thin film dielectric layer 185. Referring to FIG. 2C-6, a protection layer 195 is formed to cover the top of the bandpass filter. Referring to FIG. 2C-7, a stick break operation is carried out to break the wafer into a plurality of sticks. In FIG. 2C-8, a metal mask is applied to sputter a conductive layer 196 then a slice operation is carried out to divide the sticks into a plurality of chips 197 as shown in FIG. 2C-9, and a barrel plating is performed to formed the signal input and output connections 198 for each chip.

FIG. 3A is a circuit diagram of another bandpass filter 200 of this invention. FIG. 3B is a top view of the micro-strip implementation supported on a substrate 205 for this BPF implemented as a semi-lump distributed circuit by a micro-strip lines. The micro-strip 220 is serial connected to the input line 210 with a serially connected capacitor 215. A second micro-strip 225 is serially connected to the micro-strip 220 to generate a high frequency resonance f_{H}. The micro-strips 220 and 225 connected in parallel to a capacitor 228 to generate a resonance frequency at a transmission frequency f0. The micro-strips 220 and 225 combined with a pair coupled micro-strip 230 and 235 with a another capacitor 240 connected in parallel that in combination with an external feedback capacitor 250 to generate a low frequency resonance at a low frequency f_{L}. Additionally, the micro-strips 220 and 225 combined with a pair coupled micro-strip 230 and 235 generate a parallel resonator combined with an a feedback capacitor as that described below further generate a low frequency resonance at a low frequency f_{L}. The BPF 200 is configured as a low frequency depression BPF for transmitting a band-pass signal with a depressed low frequency with reduced low frequency noises.

Referring to FIG. 4A for a circuit diagram of a bandpass filter 300 of this invention wherein a capacitor 310 is added to the input end of the BPF. FIG. 4B shows the attenuation of the transmission signal. The low frequency noise 310′ as shown is further depressed when compared to the conventional BPF signal transmissions.

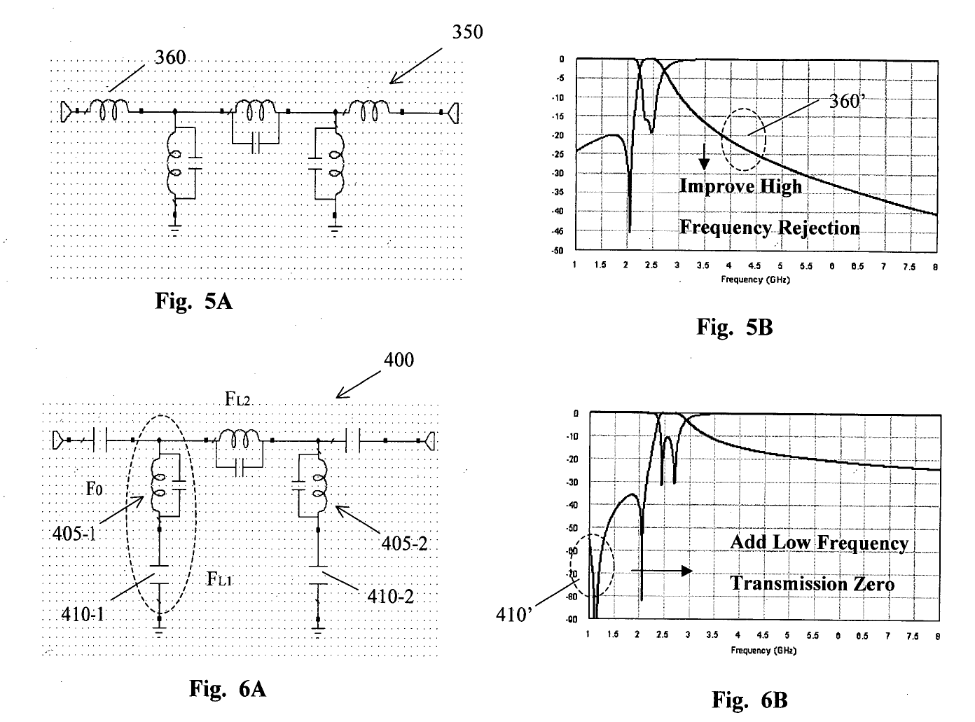

Referring to FIG. 5A for a circuit diagram of a bandpass filter 350 of this invention wherein an inductor 360 is added to the output end of the BPF. FIG. 5B shows the attenuation of the transmission signal. The high frequency noise 360′ as shown is further depressed when compared to the conventional BPF signal transmissions.

Referring to FIG. 6A for a circuit diagram of a bandpass filter 400 of this invention wherein a capacitor 410-1 is added that is connected between the resonator 405-1 and the ground terminal of the BPF to add a transmission zero point to the BPF. Also, a capacitor 410-2 is added and connected between the 405-2 and the ground terminal of the BPF. As the two resonators 405-1 and 405-2 connected in parallel have a resonance frequency at f0, for low frequency signals, these two resonators have an equivalent electrical function of inductor. Therefore, for the low frequency signals, the capacitor 410-1 now added can function together with the equivalent inductor provided by the two resonators 410-1 and 410-2 to resonate a low frequency zero transmission point f_{L}. FIG. 6B shows the attenuation of the transmission signal. The low frequency noise 460′ as shown is further depressed when compared to the conventional BPF signal transmissions.

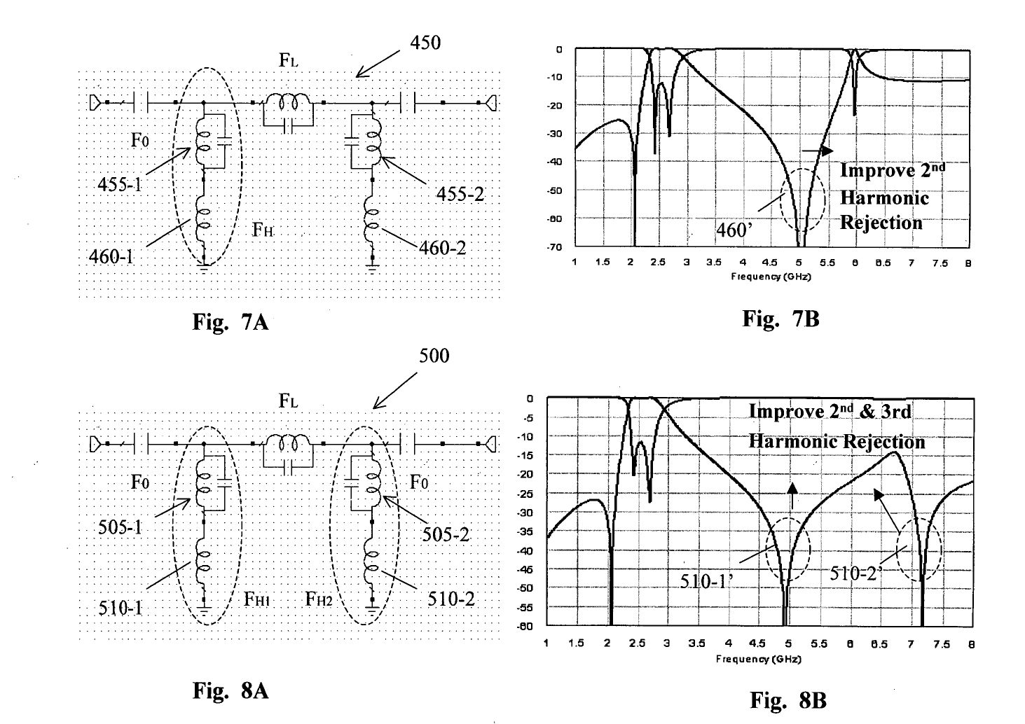

Referring to FIG. 7A for a circuit diagram of a bandpass filter 450 of this invention wherein an inductor 460-1 is added that is connected between the resonator 455-1 and the ground terminal. Also, an inductor 460-2 is added and connected between the resonators 405-2 and the ground terminal of the BPF. As the two resonators 455-1 and 455-2 connected in parallel have a resonance frequency at f0, for high frequency signals, these two resonators have an equivalent electrical function of capacitor. Therefore, for the high frequency signals, the inductor 460-1 now added can function together with the equivalent capacitor provided by the two resonators 410-1 and 410-2 to resonate a high frequency zero transmission point f_{H}. FIG. 7B shows the attenuation of the transmission signal. By properly selecting the inductance of the inductor 460-1, the high frequency noise 460′ at a second harmonic frequency, i.e., twice the resonance frequency 2*f0, is further depressed when compared to the conventional BPF signal transmissions as clearly illustrated in FIG. 7B.

Referring to FIG. 8A for a circuit diagram of a bandpass filter 500 of this invention wherein an inductor 510-1 is added that is connected between the resonator 505-1 and the ground terminal. Also, an inductor 510-2 is added and connected between the resonators 505-2 and the ground terminal of the BPF. The inductors 510-1 and 510-2 are non-symmetrical. As the two resonators 505-1 and 505-2 connected in parallel have a resonance frequency at f0, for high frequency signals, these two resonators have an equivalent electrical function of capacitor. Therefore, for the high frequency signals, the inductor 510-1 now added can function together with the equivalent capacitor provided by the two resonators 505-1 and 505-2 to resonate a first high frequency zero transmission point f_{H1} wherein f_{H1} is a second harmonic frequency. For the high frequency signals, the inductor 505-2 now added can function together with the equivalent capacitor provided by the two resonators 505-1 and 505-2 to resonate a second high frequency zero transmission point f_{H2} wherein f_{H2} is a third harmonic frequency. FIG. 8B shows the attenuation of the transmission signal. By properly selecting the inductance of the inductors 510-1 and 510-2 the high frequency noise 510-1′ is at a second harmonic frequency, i.e., twice the resonance frequency 2*f0, and the high frequency noise 510-2′ is at a third harmonic frequency, i.e., trice the resonance frequency 3*f0 are further depressed when compared to the conventional BPF signal transmissions as clearly illustrated in FIG. 8B.

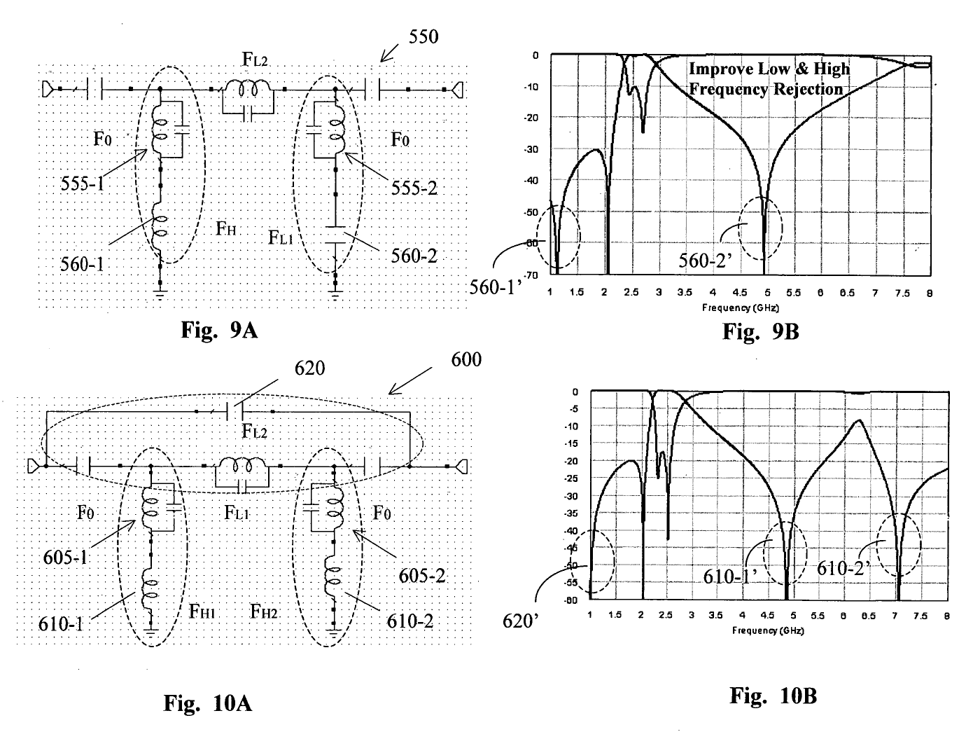

Referring to FIG. 9A for a circuit diagram of a bandpass filter 550 of this invention wherein an inductor 560-1 is added that is connected between the resonator 555-1 and the ground terminal. Also, a capacitor 560-2 is added and connected between the resonators 555-2 and the ground terminal of the BPF. As the two resonators 555-1 and 555-2 connected in parallel have a resonance frequency at f0, for high frequency signals, these two resonators have an equivalent electrical function of capacitor. Therefore, for the high frequency signals, the inductor 560-1 now added can function together with the equivalent capacitor provided by the two resonators 555-1 and 555-2 to resonate a first high frequency zero transmission point f_{H} wherein f_{H} is a second harmonic frequency. For the low frequency signals, the capacitor 560-2 now added can function together with the equivalent inductor provided by the two resonators 555-1 and 55-2 to resonate a low frequency zero transmission point f_{L}. FIG. 8B shows the attenuation of the transmission signal. By properly selecting the inductance of the inductors 560-1 the high frequency noise 510-1′ is at a second harmonic frequency, i.e., twice the resonance frequency 2*f0, is depressed as shown in 560-1′ and the low frequency noise is also depressed as shown in 560-2′ when compared to the conventional BPF signal transmissions as clearly illustrated in FIG. 8B.

Referring to FIG. 10A for a circuit diagram of a bandpass filter 600 of this invention that is basically the same as the circuit of BPF 500 as that shown in FIG. 8A. An inductor 610-1 is added that is connected between the resonator 605-1 and the ground terminal. Also, an inductor 610-2 is added and connected between the resonators 605-2 and the ground terminal of the BPF. The inductors 610-1 and 610-2 are non-symmetrical. The added inductors 610-1 and 610-2 generates two zero transmission points at the second and third harmonic resonance frequencies shown as 560-1′ and 560-2′ in FIG. 10B, as that described above. An feedback coupling capacitor 620 is added between the input and output terminals to generate a low frequency zero transmission point at frequency f_{L} shown as 620′ in FIG. 10B.

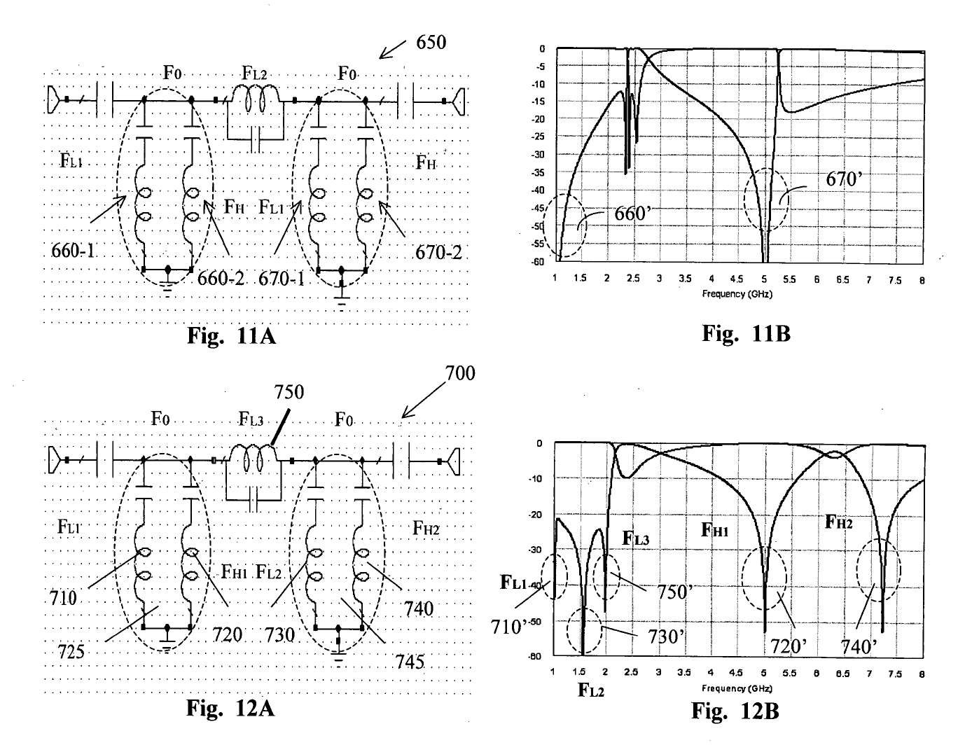

Referring to FIG. 11A for a circuit diagram of a bandpass filter 650 of this invention configured as symmetrical resonator wherein a first pair of serial connected resonator 660-1 and 660-2 each includes a capacitor and an inductor generate a zero transmission point at a low frequency 660′ shown in FIG. 11B as f_{L}. A second pair of resonators 670-1 and 670-2 each includes a capacitor and an inductor generate a zero transmission point at a high frequency 670′ shown in FIG. 11B as frequency f_{H}.

Referring to FIG. 12A for a circuit diagram of a bandpass filter 700 of this invention configured as a combined resonator that includes five nonsymmetrical resonators. The first pair of nonsymmetrical resonators 710 and 720 connected in parallel wherein the resonator 710 has a zero transmission resonance frequency at a first low frequency fL1 the resonator 720 has a zero transmission resonance frequency at a first high frequency fH1. The first pair of resonators 710 and 720 further functions as a first combined resonator 725 with a transmission resonance frequency f0. The second pair of nonsymmetrical resonators 730 and 740 connected in parallel wherein the resonator 730 has a zero transmission resonance frequency at a second low frequency fL2 the resonator 740 has a zero transmission resonance frequency at a second high frequency fH2. The second pair of resonators 730 and 740 further functions as a second combined resonator 745 with a transmission resonance frequency f0. The first combined resonator 725 is connected to the second combined resonator 745 via a serially-interconnected resonator 750 with a third zero-transmission low frequency fL3. FIG. 12B shows the waveform of the BPF with five zero transmission frequencies having depressed signals at corresponding zero transmission frequencies 710′, 720′, 730′, 740′ and 750′. The bandpass signal f0 is now transmitted through this BPF 700 with reduced noises at high and low frequencies when compared to the conventional BPF.

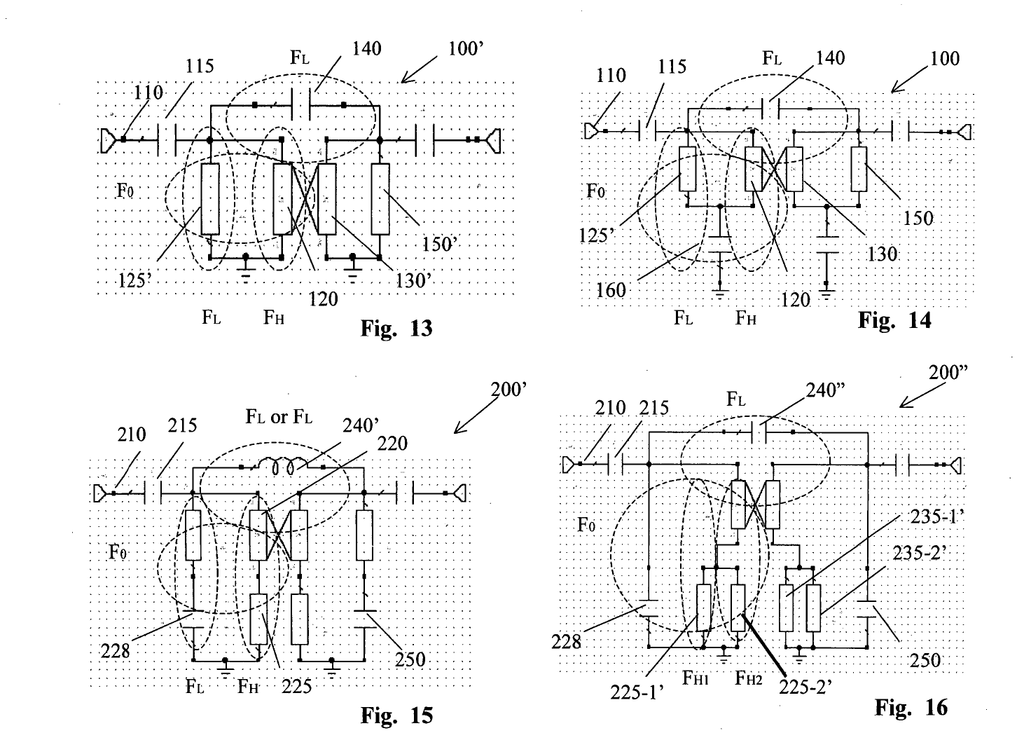

The bandpass filter as described above can be implemented by using micro-strip as that described in FIGS. 2A to 2C and 3A to 3B. Referring to FIG. 2A again, the capacitors 125 and 150 is now replaced with two micro-strips 125′ and 150′ respectively as that shown in FIG. 13. The lengths of the microstrips 125′ and 150′ are adjusted to generate a low zero-transmission resonance frequency fL and a high zero-transmission resonance frequency fH for reducing the low and high signal transmissions outside of the designed transmission band of the BPF.

Referring to FIG. 14, a pair of feedback capacitor 1060 and 170 are connected to the resonators that function together with the coupling microstrips 120 and 130 to generate a zero-transmission resonance low frequency fL for further reducing the transmission of the low frequency signals outside of the designed passband of the BPF.

The microstrip implementation can also be applied to modify the BPF 200 as that shown in FIG. 3A by replacing the capacitor 240 with a microstrip 240′ to function as an inductor. By adjusting the length of the microstrip, the microstrip combined with the capacitor formed between the coupling microstrips function as a resonator having a combined resonator a zero-transmission frequency at either a high or low resonance frequency fL or fH to reduce the high or low frequency signal transmissions outside of the designed passband of the BPF.

FIG. 16 shows a BPF 200′ as a variation of the BPF 200 shown in FIG. 3A wherein two microstrips 225-1′ and 225-2′ and 235-1′ and 235-2′ are formed to replace the microstrips 225 and 235 of BPF 200 in FIG. 3A respectively. The resonators formed are designed to resonate at a second and third harmonic resonance frequencies to depress a second and third harmonic high frequency noises. Additionally, the combined inductor functions together with the feedback capacitor 240 further functions as a resonator with a zero-transmission low frequency at fL to depress the low frequency noises.

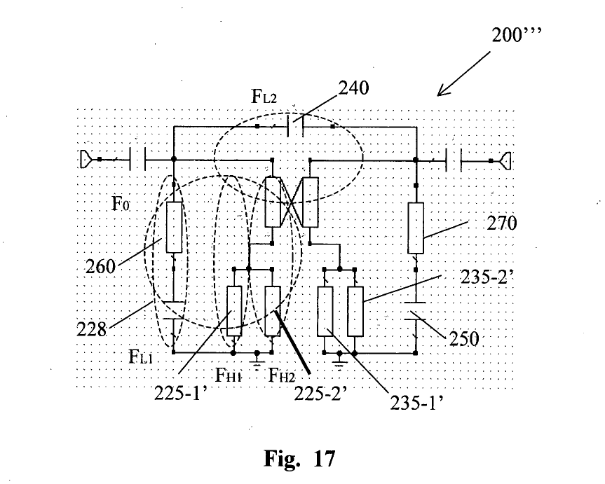

FIG. 17 shows a BPF 200″′ as a variation of the BPF 200″shown in FIGS. 3A and 16 wherein two microstrips 225-1′ and 225-2′ and 235-1′ and 235-2′ are formed to replace the microstrips 225 and 235 of BPF 200 in FIG. 3A respectively. Furthermore, two microstrips are serially connected to the parallel capacitors 228 and 250 respectively. The microstrips are function as inductors to function with the capacitors as resonator thus generate another zero-transmission low frequency at fL1 to further depress the low frequency noises.

According to FIGS. 2A to 17 and above descriptions, this invention discloses a filter circuit that includes a thin film layer supported on a substrate serving as a medium layer for a capacitor formed between a top electrode layer and a bottom electrode layer formed above and below the thin film layer. The top electrode layer is patterned into microstrips for functioning as an inductor for the filter circuit.

This invention further discloses a method for manufacturing a filter circuit. The method includes a step of forming a thin film layer on a substrate to function as a medium layer and forming a capacitor by forming a top electrode layer and a bottom electrode layer above and below the thin film layer. The method further includes a step of patterning the top electrode layer into a microstrip for functioning as an inductor for the filter circuit.

In essence, this invention discloses a BPF that includes a top electrode layer and a bottom electrode layer disposed above and below a thin dielectric layer supported on a substrate wherein the top and bottom electrode layer having microstrips to function as inductors and capacitors. And, the bandpass filter further includes an attenuated transmission frequency outside of a bandpass frequency rang of the bandpass filter.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A filter circuit comprising:
a thin film layer supported on a substrate serving as a medium layer for a capacitor between a top electrode layer and a bottom electrode layer formed above and below said thin film layer wherein said top electrode layer further comprising a microstrip for functioning as an inductor for said filter circuit.

2. The filter circuit of claim 1 wherein:
said thin film layer is a thin film layer composed of a dielectric material.

3. The filter circuit of claim 1 wherein:
said thin film layer is a silicon nitride layer.

4. The filter circuit of claim 1 wherein:
said top electrode layer further comprising at least two microstrips each functioning as an inductor and coupled as a capacitor.

5. The filter circuit of claim 1 further comprising:
an adhesion layer disposed between said thin film layer and said bottom electrode layer.

6. The filter circuit of claim 1 further comprising:
an adhesion layer comprising titanium (Ti), titanium tungsten (TiW) and nickel chromium (NiCr) disposed between said thin film layer and said bottom electrode layer.

7. The filter circuit of claim 1 wherein:
said bottom electrode layer comprising copper, silver or gold.

8. The filter circuit of claim 1 wherein:
said top electrode layer comprising copper, silver or gold.

9. The filter circuit of claim 1 further comprising:
a glass layer printed onto said substrate disposed below said bottom electrode layer.

10. The filter circuit of claim 1 further comprising:
a ground layer disposed on a bottom surface of said substrate.

11. The filter circuit of claim 1 wherein:
said substrate further comprising an aluminum oxide substrate.

12. The filter circuit of claim 1 further comprising:
a protection layer overlying said top electrode for protecting said filter circuit.

13. The filter circuit of claim 1 further comprising:
a side-wrapping-around ground-connection layer for wrapping around a side surface of said substrate for connecting a circuit element on a top surface to said ground layer disposed on said bottom surface of said substrate.

14. The filter circuit of claim 1 further comprising:
a side-wrapping-around signal-connection layer for wrapping around a side surface of said substrate to function as a side terminal for connecting to a signal input or output terminal to said filter circuit.

15. The filter circuit of claim 1 wherein:
said filter circuit comprising a bandpass filter (BPF).

16. A bandpass filter (BPF) comprising:
a thin film dielectric layer supported on an aluminum oxide substrate wherein said thin film dielectric layer serving as a medium layer for a capacitor between a top metallic electrode layer and a bottom metallic electrode layer formed above and below said thin film dielectric layer wherein said top electrode layer further comprising a microstrip for functioning as an inductor for said BPF;
said top electrode layer further comprising at least two microstrips each functioning as an inductor and coupled as a capacitor;
an adhesion layer disposed between said thin film layer and said bottom electrode layer;
a glass layer printed onto said substrate disposed below said bottom electrode layer;
a ground layer disposed on a bottom surface of said substrate;
a protection layer overlying said top electrode for protecting said filter circuit;
a side-wrapping-around ground-connection layer for wrapping around a side surface of said substrate for connecting a circuit element on a top surface to said ground layer disposed on said bottom surface of said substrate; and
a side-wrapping-around signal-connection layer for wrapping around a side surface of said substrate to function as a side terminal for connecting to a signal input or output terminal to said filter circuit.

17. The bandpass filter of claim 16 wherein:
said thin film layer is a silicon nitride layer.

18. The bandpass filter of claim 16 wherein:
said adhesion layer comprising titanium (Ti), titanium tungsten (TiW) and nickel chromium (NiCr) disposed between said thin film layer and said bottom electrode layer.

19. The bandpass filter of claim 16 wherein:
said bottom electrode layer comprising copper, silver or gold.

20. The filter circuit of claim 1 wherein:
said top electrode layer comprising copper, silver or gold.

21. A bandpass filter comprising:
a top electrode layer and a bottom electrode layer disposed above and below a thin dielectric layer supported on a substrate wherein said top and bottom electrode layer having microstrips to function as inductors and capacitors; wherein
said bandpass filter further having an attenuated transmission frequency outside of a bandpass frequency rang of said bandpass filter.

22. The bandpass filter of claim 21 wherein:
said attenuated transmission frequency is a high frequency attenuation frequency higher than said bandpass frequency rang of said bandpass filter.

23. The bandpass filter of claim 21 wherein:
said attenuated transmission frequency is a low frequency attenuation frequency lower than said bandpass frequency rang of said bandpass filter.

24. The bandpass filter of claim 21 wherein:
said attenuated transmission frequency is a high frequency attenuation frequency at a second harmonic resonance frequency of a bandpass frequency of bandpass filter.

25. The bandpass filter of claim 21 wherein:
said attenuated transmission frequency is a high frequency attenuation frequency at a third harmonic resonance frequency of a bandpass frequency of bandpass filter.

26. The bandpass filter of claim 21 wherein:
said bandpass filter having a high attenuated transmission frequency and a low attenuated transmission frequency at a higher frequency and a lower frequency respectively than said rang of said bandpass filter.

27. The bandpass filter of claim 21 wherein:
said bandpass filter having at least two high attenuated transmission frequencies and a low attenuated transmission frequency at two higher frequencies and a lower frequency respectively than said rang of said bandpass filter.

28. The bandpass filter of claim 21 wherein:
said bandpass filter having at least two low attenuated transmission frequencies and a high attenuated transmission frequency at two lower frequencies and a higher frequency respectively than said rang of said bandpass filter.

29. A method for manufacturing a filter circuit comprising:
forming a thin film layer on a substrate to function as a medium layer and forming a capacitor by forming a top electrode layer and a bottom electrode layer above and below said thin film layer; and
patterning said top electrode layer into a microstrip for functioning as an inductor for said filter circuit.

30. The method of claim 29 wherein:
said step of forming said thin film layer is a step of forming said thin film layer with a dielectric material.

31. The method of claim 29 wherein:
said step of forming said thin film layer is a step of forming said thin film layer as a silicon nitride layer.

32. The method of claim 29 wherein:
said step of patterning said top electrode layer further comprising a step of patterning said top electrode layer into at least two microstrips each functioning as an inductor and coupled as a capacitor.

33. The method of claim 29 further comprising:
disposing an adhesion layer between said thin film layer and said bottom electrode layer.

34. The method of claim 29 further comprising:
employing titanium (Ti), titanium tungsten (TiW) or nickel chromium (NiCr) for forming an adhesion layer between said thin film layer and said bottom electrode layer.

35. The method of claim 29 wherein:
said step of forming said bottom electrode layer comprising a step of employing copper, silver or gold to form said bottom electrode layer.

36. The method of claim 29 wherein:
said step of forming said top electrode layer comprising a step of employing copper, silver or gold to form said top electrode layer.

37. The method of claim 29 further comprising:
printing a glass layer onto said substrate for disposing said glass layer below said bottom electrode layer.

38. The method of claim 29 further comprising:
forming a ground layer on a bottom surface of said substrate.

39. The method of claim 29 wherein:
said step of supporting said bandpass filter on said substrate further comprising a step of employing an aluminum oxide substrate for supporting said bandpass filter.

40. The method of claim 29 further comprising:
forming a protection layer overlying said top electrode for protecting said filter circuit.

41. The method of claim 29 further comprising:
wrapping around a side surface of said substrate with a side-wrapping-around ground-connection layer for connecting a circuit element on a top surface to a ground layer disposed on a bottom surface of said substrate.

42. The method of claim 29 further comprising:
wrapping around a side surface of said substrate with a side-wrapping-around signal-connection layer to function as a side terminal for connecting to a signal input or output terminal to said filter circuit.

43. The method of claim 29 wherein:
said method of forming said filter circuit comprising a step of forming said filter circuit as a bandpass filter (BPF).
